(19) United States
(12) Patent Application Publication
(10) Pub. No.: US 2005/0199752 A1
(43) Pub. Date: Sep. 15, 2005

(54) Aerosol dispensing apparatus and method of use

(76) Inventor: Ryan L. Marsden, Fort Wayne, IN (US)

Correspondence Address: LAW OFFICES OF BRIAN C. PAULS, 919 SOUTH HARRISON STREET, SUITE 320, FORT WAYNE, IN, 46802, US

(21) Appl. No.: 11/071,676

(22) Filed: Mar. 3, 2005

Related U.S. Application Data
(60) Provisional application No. 60/551,957, filed on Mar. 10, 2004.

(51) Int. Cl. B05B 9/04; B05B 9/047; B05B 11/02; E03B 1/00; E03C 1/00; F17D 1/00

(52) U.S. Cl. 239/322

(57) ABSTRACT

A dispensing apparatus mountable within a shower structure that includes a housing and a pressurized container. The container has a valve assembly with a projecting valve stem. The contents of the container are released by biasing the valve stem relative to the container. The valve stem is in communication with a nozzle passage having a restriction and the container contents released into the nozzle passage are atomized by the restriction and discharged from the housing as an aerosol. The valve stem may be positioned in a horizontal orientation and be biased into engagement with an actuating member that is fixed relative to the housing by sliding the container relative to both the housing and the actuating member. A method of providing a substance for inhalation by a person by aerially dispersing the substance in a shower structure is also disclosed.

### CROSS REFERENCE TO RELATED APPLICATIONS

This application claims priority under 35 U.S.C. 119(e) of U.S. provisional patent application Ser. No. 60/551,957 filed on Mar. 10, 2004 entitled THERAPEUTIC VAPOR DISPENSING DEVICE USED IN SHOWER the disclosure of which is hereby incorporated herein by reference.

### BACKGROUND OF THE INVENTION

1. Field of the Invention

The present invention relates to aerosol dispensing devices and, more particularly, to aerosol dispensing devices for dispersing substances useful in aromatherapy or inhalation therapy.

2. Description of the Related Art

Various forms of devices are known for aerially dispersing substances used in aromatherapy or inhalation therapy. Aromatherapy involves the aerial dispersal of a substance which is then inhaled by persons within the dispersal area. The substances typically used in such aromatherapy produce a pleasant fragrance and are thought by many people to have a soothing or calming effect. The dispersers used in aromatherapy may take various forms and often employ a source of heat to warm an essential oil or similar substance to facilitate the evaporation and resulting aerial dispersal of the substance.

Inhalation therapy or vapor therapy typically involves inhaling steam, i.e., warm water vapor. The steam can be provided in a variety of different manners. For example, such inhalation therapy can be accomplished by boiling a pot of water and placing a towel over one's head to confine the water vapors produced by the heated water. A variety of vaporizers are also known which heat water to produce steam and provide a mouthpiece or similar outlet through which the steam can be more conveniently inhaled. Such vaporizers may also provide a means for mixing the steam with a cough suppressant or other therapeutic inhalant to thereby produce a medicated steam vapor.

While such aromatherapy dispersers and vaporizers are effective for their purposes, additional means for aerially dispersing a substance for inhalation are also desirable.

### SUMMARY OF THE INVENTION

The present invention provides an aerosol dispensing apparatus that can be mounted within a shower structure and used to aerially dispense a substance such as those used for vapor therapy and/or aromatherapy purposes.

The invention comprises, in one form thereof, a dispensing apparatus for mounting within a shower structure. The apparatus includes a housing mountable within the shower structure and a container removably supported by the housing. The container has a valve assembly with a projecting valve stem. The pressurized contents of the container are selectively released through the valve stem by biasing the valve stem relative to the container. The valve stem is in communication with a nozzle passage having a restriction. The nozzle passage and restriction are defined by the housing. The container contents released through the valve stem into the nozzle passage are atomized by the restriction and discharged from the housing as an aerosol.

The invention comprises, in another form thereof, a dispensing apparatus for mounting within a shower structure which includes a housing mountable within the shower structure and a container with pressurized contents. The container includes a valve assembly with a projecting valve stem. A support member is disposed on the housing and supportingly engages the container. An actuating member is also disposed on the housing and is fixed relative to the housing. The actuating member is operably coupled with the valve stem. The contents of the container are selectively releasable from the container by moving the container relative to both the actuating member and the housing thereby biasing the valve stem relative to the container and selectively releasing the contents through the valve stem.

In some embodiments, the housing of the dispenser can be mounted on a vertically oriented surface within the shower structure such that the horizontal sliding motion of the container towards the actuation member biases the housing towards the vertically oriented surface. In such a configuration, the biasing forces used to release the contents of the container are oriented in a direction that is not likely to pry the housing off of the vertically oriented surface of the shower structure.

The invention comprises, in still another form thereof, a dispensing apparatus for mounting within a shower structure. The apparatus includes a housing mountable within the shower structure and a container having a valve assembly with a projecting valve stem wherein the valve stem defines a valve axis. The pressurized contents of the container are released through the valve stem by biasing the valve stem relative to the container along the valve axis. A support member is disposed on the housing and supportingly engages the container with the valve axis disposed in a substantially horizontal orientation. An actuating member is disposed on the housing and is operably coupled to the valve stem.

The invention comprises, in yet another form thereof, a method of providing a substance for inhalation by a person. The method includes mounting a housing within a shower structure and providing the substance within a pressurized container. The container is supported on the housing and the substance is selectively released from the container with the container supported on the housing. The released substance is then aerially dispersed within the shower structure where it can be inhaled by a person within the shower structure. This method may also include the step of releasing water through a shower head contemporaneously with the step of selectively releasing the substance from the container. Furthermore, the step of aerially dispersing the released substance may also include mixing the released substance with water vapor generated by the release of water through the shower head.

An advantage of the present invention is that provides a convenient mechanism for mixing a substance with water vapor within a shower structure whereby the substance and water vapors can be inhaled by a person taking a shower.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a view of a dispensing apparatus in accordance with the present invention mounted within a shower structure.

FIG. 2 is an exploded side view of the dispensing apparatus.

FIG. 3 is a front view of the housing.

FIG. 4 is a rear view of the housing.

FIG. 5 is an exploded top view of apparatus.

FIG. 6 is a detail view of an actuating member and valve stem.

FIG. 7 is a side view of an alternative embodiment.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

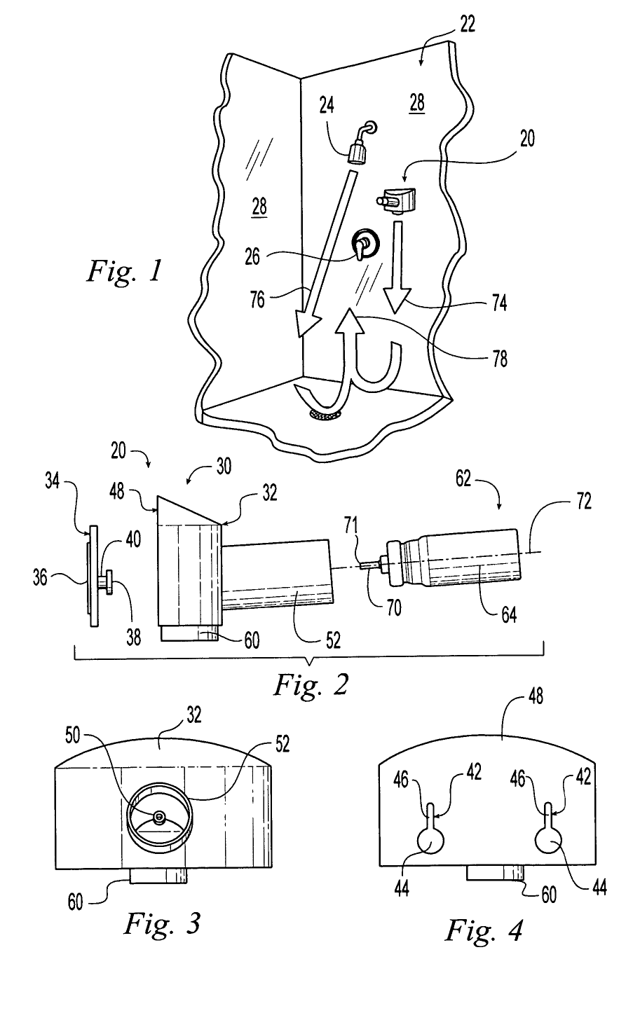

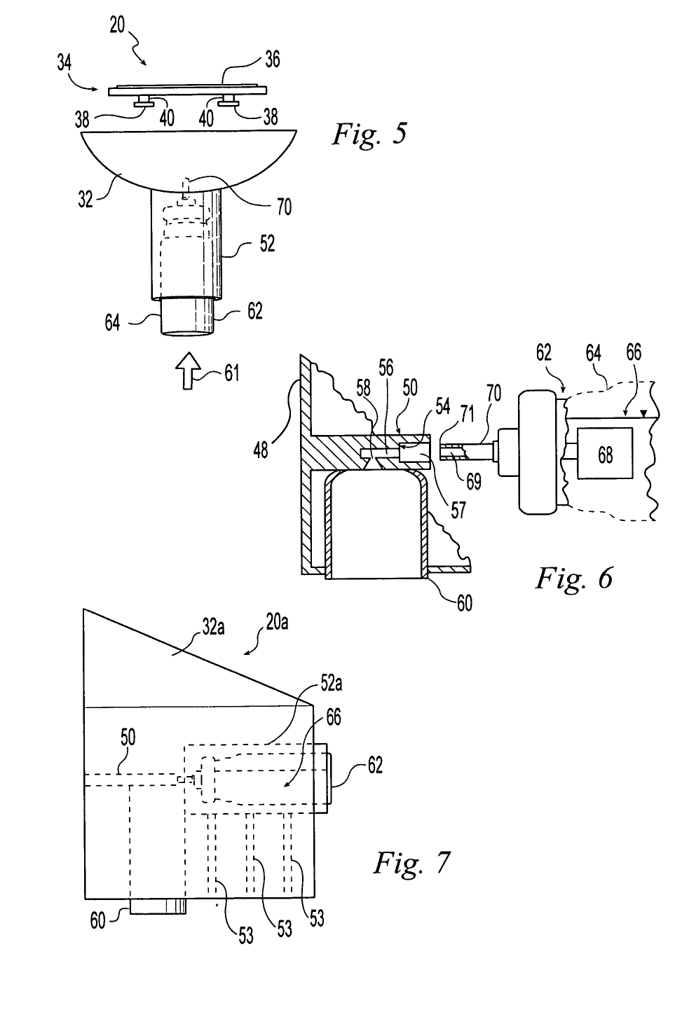

A dispensing apparatus 20 in accordance with the present invention is shown in FIG. 1 mounted within a shower structure 22. Shower structure 22 is a conventional shower having a shower head 24 and a valve handle 26 for turning on the water, i.e., discharging water through shower head 24, and controlling the temperature of the water discharged through shower head 24. In the illustrated embodiment, shower structure 22 is a conventional shower stall having a plurality of vertically oriented surfaces 28, e.g., tiled wall surfaces, and a glass door (not shown). The present invention, however, may also be employed with a wide variety of other shower structures. For example, apparatus 20 may also be employed with a conventional shower structure that includes a shower head that discharges into a bathtub and employs a shower curtain to enclose one or more sides of the bathtub.

Dispensing apparatus 20 includes a housing 30 which includes a dispensing structure 32 that takes the form of a shell in the illustrated embodiment and a mounting plate 34. Mounting plate 34 is secured to a shower wall surface 28 with an attachment feature 36 that is suitable for use in a shower environment. In other words, attachment feature 36 can be exposed to water and still secure mounting plate 34 to shower wall surface 28. In the illustrated embodiment, attachment feature 36 is a waterproof adhesive, however, other attachment features, such as a threaded fastener or other mechanical attachment device could also be employed to secure mounting plate 34 to surface 28. An example of a water proof adhesive that may be used with the present invention is PL® Multi-Purpose Contruction Adhesive commercially available from OSI Sealants, Inc., a subsidiary of Sovereign Specialty Chemicals, having a place of business at 7405 Production, Mentor, Ohio, 44060.

After mounting plate 34 has been mounted within shower structure 22, housing shell 32 can be mounted on plate 34. Plate 34 includes two cylindrical projections 38 which each have an annular groove 40. The rear wall 48 of housing shell 32 includes two corresponding keyhole slots 42 which each include an enlarged opening 44 and a narrow slot 42. To mount housing shell 32 on plate 34, projections 38 are inserted through enlarged openings 44, annular grooves 40 are then aligned with slots 42 and housing shell 32 is slid downwardly on projections 38 to securely mount shell 32 on plate 34. By providing two projections 38 and interfitting keyhole slots 42, the pivotal movement of housing shell 32 relative to mounting plate 34 is prevented.

Housing 30 also includes an actuating member 50 and support member 52 which actuate and support container 62 respectively. Actuating member 50 is integrally formed with and fixed relative to housing shell 32. Actuating member 50 includes a nozzle passage 56 with a restriction 58 for dispensing an aerosol product from container 62 as discussed in greater detail below. The aerosol product is conveyed out of housing shell 32 from nozzle passage 56 by discharge tube 60. Support member 52 is a generally cylindrical tube that is shaped to support and properly align container 62 with actuating member 50. Housing 30 may be manufactured by injection molding a polymeric material, e.g., polyvinyl chloride (PVC). Housing shell 32 may be formed by joining a plurality of injection molded pieces together using either snap fit connections, a water proof adhesive or other suitable means. Other water resistant materials and manufacturing methods may also be employed to form housing 30.

Container 62 includes an aluminum cylinder portion 64 which holds pressurized contents 66 of container 62 until they are released from container 62 by a user. To control the release of the pressurized contents 66, container 62 includes a valve assembly 68 having a projecting valve stem 70. Container 62, including valve assembly 68, have a conventional construction well known to those having ordinary skill in the art. An example of a pressurized container having a valve assembly that provides for the release of an aerosol product when the container is in a horizontal orientation and which can be adapted for use with the present invention is disclosed by Parsons in U.S. Pat. No. 5,839,624 which is hereby incorporated herein by reference.

The valve stem end of container 62 is inserted into support tube member 52 when installing container 62 in housing 30. As best seen in FIG. 2, valve stem 70 defines a valve axis 72 which is positioned substantially horizontal when container 62 is mounted in support tube 52. As best understood with reference to FIG. 6, when installing container 62, support tube 52 properly aligns container 62 such that valve stem 70 is received in opening 57 of actuating member 50 with the distal end 71 of valve stem 70 abuttingly engaged with annular surface 54. When distal end 71 is engaged with annular surface 54, valve stem passageway 69 is placed in communication with nozzle passageway 56. Support tube 52 has a slight upward inclination as it projects outwardly away from rear wall 48, forming an angle of about 2-3 degrees with a horizontal plane. This slight inclination helps to maintain container 62 within support tube 52 with valve stem 70 disposed in opening 57.

To release the pressurized contents 66 of container 62, container 62 is slid horizontally within support tube 52 along valve axis 72 with a biasing force 61. For example, a user may push container 62 along axis 72 with his or her hand to provide biasing force 61. As container 62 is slid within support tube 52 by biasing force 61, distal end 71 of valve stem 70 is biased against annular engagement surface 54. This forces valve stem 70 into container 62 thereby opening valve assembly 68 and allowing contents 66 to enter valve stem passageway 69. A gas at relatively high pressure is contained within container 62 along with contents 66 to forcibly discharge contents 66 when valve assembly 68 is opened. From valve stem passageway 69 the contents 66 are forced into nozzle passageway 56. After entering nozzle passageway 56, the contents pass through restriction 58 in passageway 56 before being discharged into discharge tube 60 and then exiting housing 30 into the surrounding environment. Restriction 58 atomizes the liquid contents 66 being discharged from container 62 so that contents 66 are discharged from nozzle passageway 56 as an aerosol. Such restrictions for atomizing a fluid in the discharge nozzle of a pressurized aerosol canister are well known to those having ordinary skill in the art.

Actuating member 50 is fixed relative to the remainder of housing shell 32. Thus, housing 30 does not have any moving parts and biasing force 61 moves container 62 relative to both actuating member 50 and the remainder of housing shell 32 to depress valve stem 70 and thereby selectively release the contents 66 of container 62. Biasing force 61 is oriented along axis 72 and is therefore oriented substantially transverse to vertical surface 28 on which housing 30 is mounted. Consequently, biasing force 61 presses housing 30 against surface 28 in a manner that reinforces the bond formed by adhesive 36. In contrast, if housing 30 were configured such that the biasing force used to open valve assembly 68 were oriented in a downward direction, the downward biasing force could have a tendency to pry housing 30 away from surface 28 and thereby lead to the premature failure of the adhesive bond securing the housing to the shower wall.

Once container 62 has been depleted, it can be easily removed from support tube 52 and replaced with a new container 62. Alternatively, a user may purchase several containers 62, each of which contain a different substance for release, to thereby allowing the user to interchange the containers and use any one of a variety of different substances when taking a shower.

The liquid contents 66 within container 62 may be either aromatherapy substances which provide a pleasing fragrance, e.g., essential oils, or vapor therapy substances that have a physiological as well as psychological effect. Essential oils that may be used in container 62 include lavender essential oil, eucalyptus essential oil, jasmine essential oil, etc. Such essential oils are commercially available from a number of different sources including The Body Shop International PLC having a place of business at 5036 One World Way, Wake Forest, N.C., 27587. An example of a vapor therapy substance that can be used with container 62 is Vicks VapoSteam brand liquid medication for hot steam vaporizers which includes 6.2% camphor (a cough suppressant) as an active ingredient and inactive ingredients that include alcohol (78%), cedarleaf oil, eucalyptus oil, laureth-7, methol, nutmeg oil, poloxamer 124 and silicone. Vicks VapoSteam is commercially available from Proctor & Gamble Co. having a place of business at 1 Proctor & Gamble Plaza, Cincinnati, Ohio, 45202. Another vapor therapy substance that can be used in container 62 is Kaz Inhalent commercially available from KAZ, Incorporated having a place of business at 1775 Broadway, Suite 2405, New York, N.Y., 10019.

The use of dispensing apparatus 20 is best understood with reference to FIG. 1. When container 62 is biased inwardly toward actuating member 50 by biasing force 61, contents 66 are dispensed through discharge tube 60 into the air within shower structure 24 as an aerosol as schematically depicted by aerosol discharge arrow 74. As depicted, the contents 66 are dispensed in a substantially downward direction from dispenser 20. A user (not shown) taking a shower will also typically “turn on” the water using valve handle 26 so that water will be discharged through shower head 24 as depicted by water discharge arrow 76. The warm water discharged through shower head 24 will generate water vapor that will tend to rise upwardly from the floor of shower structure 22. This rising water vapor will mix with the aerosol discharge 74 released from dispensing apparatus 20 to facilitate the aerial dispersal of the substances released from container 62 as schematically depicted by dispersal arrow 78. In this manner, the aerosol discharge from dispenser 20 will be dispersed within the air filling shower structure 22 thereby allowing it to be inhaled by a user within shower structure 22. Moreover, the intermingling of the aerosol discharge with water vapor generated by the discharge of water through shower head 24 will provide a mixture of the aerosol discharge and water vapor for inhalation by a user located within the shower structure 22.

It is expected that users will most often turn on the water prior to dispensing contents 66 so that the water will have already begun to generate water vapor to facilitate the dispersal of the aerosol discharge 74 when a portion of the contents 66 are released from container 62. However, this is not required and contents 66 can be released prior to turning on the water, or, a user could simply release contents 66 into the air within shower structure 24 for inhalation thereof without discharging any water from shower head 24.

An alternative embodiment 20a of a dispensing apparatus is shown in FIG. 7. Apparatus 20a is generally similar to apparatus 20 but includes a housing shell 32a having different configuration. In embodiment 20a, support tube 52a does not project outwardly from shell 32a to the same extent as support member 52 projects from shell 32. In the embodiment illustrated in FIG. 7, support tube 52a has a length that is substantially equivalent to support member 52. However, substantially all of tube 52a is located within housing shell 32a instead of projecting outwardly therefrom. Support ribs 53 located within shell 32a may be used to provide additional rigidity and support to tubular member 52a. It is also noted that the upper surface of both of the illustrated housing shells 32, 32a are sloped to prevent the ponding of water thereon. Various other housing configurations may also be employed with the present invention. For example, the housing could include an integrally formed soap dish for holding a bar of soap.

While this invention has been described as having an exemplary design, the present invention may be further modified within the spirit and scope of this disclosure. This application is therefore intended to cover any variations, uses, or adaptations of the invention using its general principles.

1. A dispensing apparatus for mounting within a shower structure; said apparatus comprising:
a housing mountable within the shower structure;
a container removably supported by said housing, said container having a valve assembly with a projecting valve stem, said container having pressurized contents contained therein, biasing of said valve stem relative to said container releasing said contents through said valve stem; and
a nozzle passage having a restriction being defined by said housing, said nozzle passage in communication with said valve stem wherein contents released through said valve stem and into said nozzle passage are atomized by said restriction and discharged from said housing as an aerosol.

2. The dispensing apparatus of claim 1 further comprising an attachment feature mounting said housing to the shower structure; said attachment feature being exposable to water when supporting said housing on the shower structure.

3. The dispensing apparatus of claim 2 wherein said attachment feature comprises a waterproof adhesive.

4. The dispensing apparatus of claim 1 wherein said housing includes a mounting plate directly securable to the shower structure and a dispensing structure removably securable to the mounting plate, said nozzle passage being defined by said dispensing structure.

5. The dispensing apparatus of claim 4 wherein said mounting plate is secured to the shower structure with a waterproof adhesive.

6. The dispensing apparatus of claim 1 wherein said housing further comprises an actuating member operably couplable to said valve stem, said actuating member defining at least a portion of said nozzle passage including said restriction.

7. The dispensing apparatus of claim 6 wherein said actuator is fixed relative to housing and wherein said container is moved relative to both said actuator and said housing to bias said valve stem and thereby selectively release said contents.

8. The dispensing apparatus of claim 1 wherein said valve stem defines a valve axis and said container is mounted on said housing with said valve axis in a substantially horizontal orientation.

9. The dispensing apparatus of claim 1 wherein said nozzle discharges the contents in a substantially downward direction.

10. A dispensing apparatus for mounting within a shower structure; said apparatus comprising:
a housing mountable within the shower structure;
a container having a valve assembly with a projecting valve stem, said container having pressurized contents contained therein;
a support member disposed on said housing and supportingly engaging said container; and
an actuating member disposed on and fixed relative to said housing, said actuating member being operably coupled with said valve stem wherein said contents of said container are selectively releasable from said container by moving said container relative to said actuating member and said housing thereby biasing said valve stem relative to said container and selectively releasing said contents through said valve stem.

11. The dispensing apparatus of claim 10 wherein said container is horizontally slidably disposed on said support member and said contents are selectively released from said container by horizontally sliding said container towards said actuating member.

12. The dispensing apparatus of claim 11 wherein said housing is mountable on a vertically oriented surface and wherein horizontal sliding motion of said container towards said actuation member biases said housing towards the vertically oriented surface in a direction substantially transverse to the vertically oriented surface.

13. The dispensing apparatus of claim 12 further comprising an attachment feature mounting said housing to the shower structure; said attachment feature being exposable to water when supporting said housing on the shower structure.

14. The dispensing apparatus of claim 10 wherein said actuating member defines a nozzle passage having a restriction, said nozzle passage in communication with said valve stem wherein contents released through said valve stem and into said nozzle passage are atomized by said restriction and discharged from said housing as an aerosol.

15. A dispensing apparatus for mounting within a shower structure; said apparatus comprising:
a housing mountable within the shower structure;
a container having a valve assembly with a projecting valve stem, said valve stem defining a valve axis; said container having pressurized contents contained therein, biasing of said valve stem relative to said container along said valve axis releasing said contents through said valve stem;
a support member disposed on said housing and supportingly engaging said container wherein said valve axis is disposed in a substantially horizontal orientation; and
an actuating member disposed on said housing and operably coupled to said valve stem.

16. The dispensing apparatus of claim 15 wherein said actuator is fixed relative to housing and wherein said container is moved relative to both said actuator and said housing to bias said valve stem and thereby selectively release said contents.

17. The dispensing apparatus of claim 15 wherein said housing is mountable on a vertically oriented surface and wherein biasing of said valve stem relative to said container to release said contents biases said housing towards the vertically oriented surface in a direction substantially transverse to the vertically oriented surface.

18. The dispensing apparatus of claim 15 wherein said actuating member defines a nozzle passage having a restriction, said nozzle passage in communication with said valve stem wherein contents released through said valve stem and into said nozzle passage are atomized by said restriction and discharged from said housing as an aerosol.

19. The dispensing apparatus of claim 15 further comprising an attachment feature mounting said housing to the shower structure; said attachment feature being exposable to water when supporting said housing on the shower structure.

20. A method of providing a substance for inhalation by a person;
mounting a housing within a shower structure;
providing the substance within a pressurized container;
supporting the container on the housing;
selectively releasing the substance from the container with the container supported on the housing; and
aerially dispersing the released substance within the shower structure.

21. The method of claim 20 further comprising the step of releasing water through a shower head contemporaneously with said step of selectively releasing the substance from the container.

22. The method of claim 21 wherein said step of aerially dispersing the released substance includes mixing the released substance with water vapor generated by said step of releasing water through the shower head.

23. The method of claim 20 wherein said step of aerially dispersing the release substance includes discharging the substance through a nozzle passage having a restriction to thereby release the substance as an aerosol within the shower structure

24. The method of claim 20 wherein the step of mounting the housing in the shower structure comprises mounting the housing with an attachment feature that can be exposed to water.

25. The method of claim 24 wherein the step of mounting the housing further comprises mounting the housing on a vertically oriented surface.

26. The method of claim 25 wherein the step of selectively releasing the substance comprises biasing a valve stem on the container against an actuating member disposed on the housing and wherein the step of biasing the valve stem against the actuating member biases the housing toward the vertically oriented surface in a direction substantially transverse to the vertically oriented surface.

27. The method of claim 20 wherein the substance selectively released from the container comprises an essential oil.
